(19) United States
(12) Patent Application Publication
(10) Pub. No.: US 2011/0283087 A1
(43) Pub. Date: Nov. 17, 2011

(54) IMAGE FORMING APPARATUS, IMAGE FORMING METHOD, AND COMPUTER READABLE MEDIUM STORING CONTROL PROGRAM THEREFOR

(75) Inventors: Tsuyoshi WATANABE, Kanagawa (JP); Yoshiaki TEZUKA, Kanagawa (JP); Kunihiko KOBAYASHI, Kanagawa (JP); Tomomichi ADEGAWA, Adegawa (JP)

(73) Assignee: FUJI XEROX CO., LTD., Tokyo (JP)

(21) Appl. No.: 12/915,528

(22) Filed: Oct. 29, 2010

(30) Foreign Application Priority Data
May 12, 2010 (JP) 2010-110284

(51) Int. Cl. G06F 15/76; G06F 9/02

(52) U.S. Cl. 712/30; 712/E09.002

(57) ABSTRACT

A first processing unit is implemented by executing a first application program by using an internal computer in an environment where a first operating system is operating. The first processing unit performs a first process or an external service call in accordance with instruction information describing a process to be executed. A second processing unit is implemented by executing a second application program by using the internal computer or an additional computer connected to the internal computer in an environment where a second operating system is operating. The second processing unit performs a second process when instructed by an external service call to execute the second process. When the instruction information includes information specifying the second process as the process to be executed, a transfer unit updates the information included in the instruction information, and transfers the updated instruction information to the first processing unit.

### CROSS-REFERENCE TO RELATED APPLICATIONS

This application is based on and claims priority under 35 USC 119 from Japanese Patent Application No. 2010-110284 filed May 12, 2010.

### BACKGROUND

### (i) Technical Field

The present invention relates to an image forming apparatus, an image forming method, and a computer readable medium storing a control program therefor.

### SUMMARY

According to an aspect of the invention, there is provided an image forming apparatus including a first processing unit, a second processing unit, a receiving unit, and a transfer unit. The first processing unit is implemented by executing a first application program by using an internal computer in an environment where a first operating system is operating. The first processing unit is configured to perform a process in accordance with instruction information describing a process to be executed. When the instruction information describes information specifying the first process as the process to be executed, the first processing unit performs a first process. When the instruction information describes information specifying the external service call as the process to be executed, the first processing unit performs an external service call. The second processing unit is implemented by executing a second application program by using the internal computer or an additional computer connected to the internal computer in an environment where a second operating system is operating. The second processing unit is configured to perform a second process when instructed by the external service call to execute the second process. The receiving unit receives set or input instruction information describing a process to be executed. When set or input instruction information is received by the receiving unit, the transfer unit finds whether or not information specifying the second process as the process to be executed is included in the received set or input instruction information. When information specifying the second process as the process to be executed is included, the transfer unit updates the information included in the instruction information to information specifying, as a process to be executed, the external service call for instructing the second processing unit to execute the second process and transfers the instruction information that has been updated to the first processing unit.

### BRIEF DESCRIPTION OF THE DRAWINGS

Exemplary embodiment(s) of the present invention will be described in detail based on the following figures, wherein:

FIG. 1 is a schematic block diagram illustrating an example configuration of an image forming apparatus;

FIG. 2A is a conceptual diagram illustrating the relationship between programs when an additional application is not provided;

FIG. 2B is a conceptual diagram illustrating the relationship between programs when an additional application is provided;

FIG. 3A is a conceptual diagram illustrating receipt of instruction information in a configuration in which an additional application is not provided;

FIG. 3B is a conceptual diagram illustrating receipt of instruction information in a configuration in which an additional application is provided;

FIG. 4 is a flowchart illustrating an instruction storage process;

FIG. 5A is an image diagram illustrating an example of instruction information that has not been updated;

FIG. 5B is an image diagram illustrating an example of instruction information that has been updated;

FIG. 6A is a conceptual diagram illustrating the execution of processing of instruction information using the storage of a file in a confidential box as a trigger, in a configuration in which an additional application is not provided;

FIG. 6B is a conceptual diagram illustrating the execution of processing of instruction information using the storage of a file in a confidential box as a trigger, in a configuration in which an additional application is provided;

FIG. 7 is a flowchart illustrating an instruction execution process;

FIG. 8 is a flowchart illustrating an instruction output process; and

FIG. 9 is a schematic block diagram illustrating another example configuration of the image forming apparatus.

### DETAILED DESCRIPTION

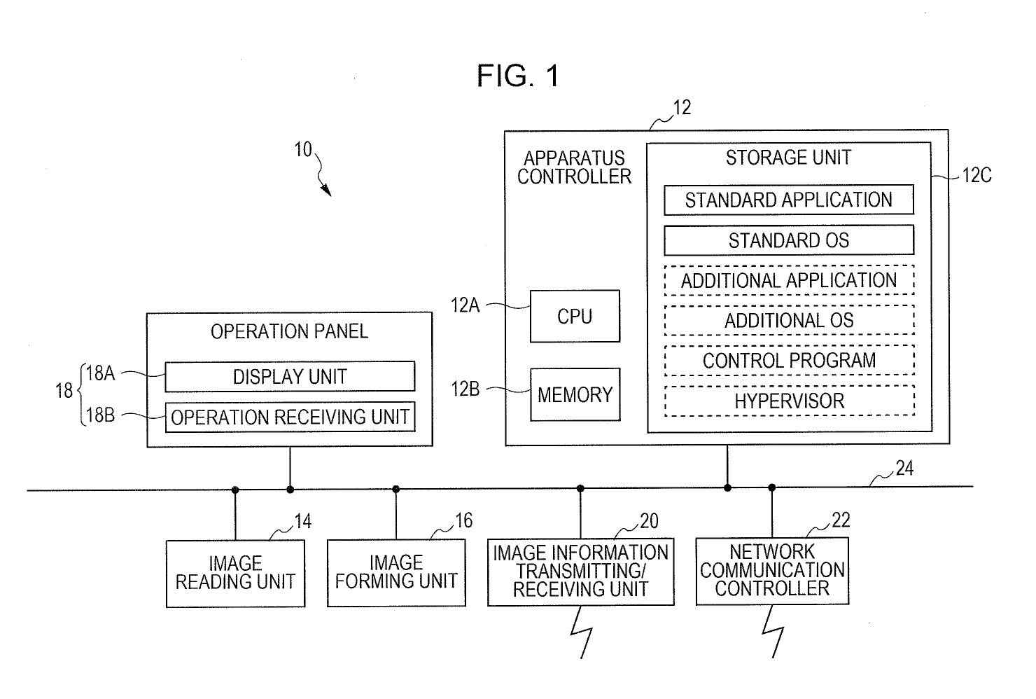

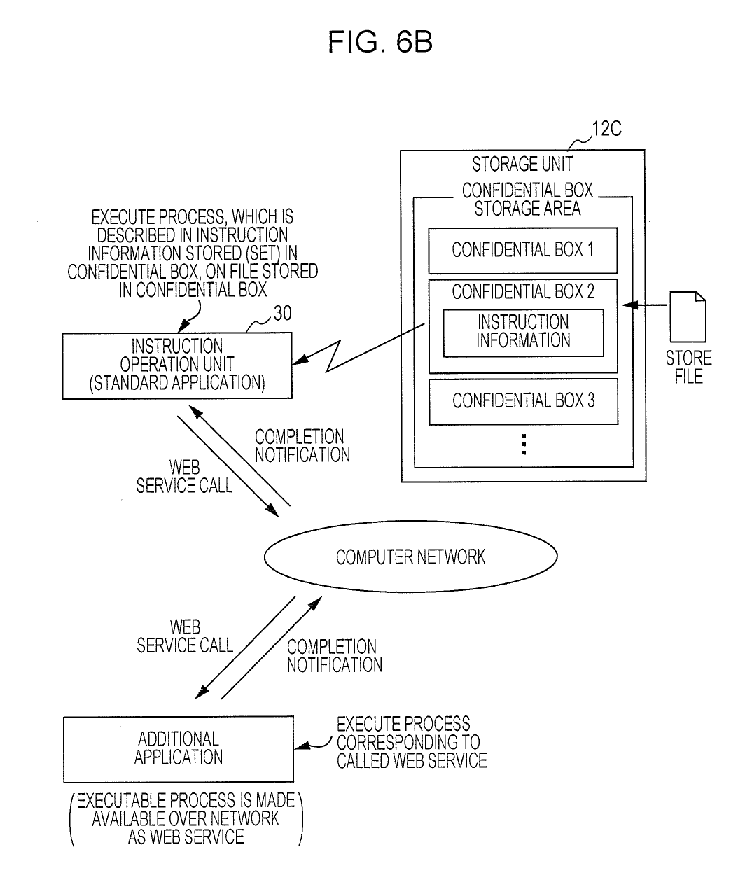

An example of an exemplary embodiment of the present invention will be described in detail with reference to the drawings. FIG. 1 illustrates an image forming apparatus 10 according to the exemplary embodiment. The image forming apparatus 10 includes an apparatus controller 12 that controls the operation of each unit of the image forming apparatus 10, an image reading unit 14 that optically reads a document (paper document) to be read which is set and that outputs read image data, and an image forming unit 16 that forms an image represented by the input image data on recording paper. The image forming apparatus 10 further includes an operation panel 18 having a display unit 18A such as a liquid crystal display (LCD) and an operation receiving unit 18B that includes a ten-key pad, a touch panel, and any other suitable device and that receives an operation performed by a user. The image forming apparatus 10 further includes an image information transmitting/receiving unit 20 that transmits and receives image information (via facsimile communication) to and from another device having a function of a facsimile machine via a telephone line and a public communication network (not illustrated), and a network communication controller 22 connected to a computer network (see FIG. 6B) via a communication cable and configured to transmit and receive information to and from a client terminal (not illustrated) such as a personal computer (PC) connected to the computer network. The apparatus controller 12, the image reading unit 14, the image forming unit 16, the operation panel 18, the image information transmitting/receiving unit 20, and the network communication controller 22 are connected to one another via a bus 24.

The apparatus controller 12 may be formed of a microcomputer or the like, and includes a central processing unit (CPU) 12A, a memory 12B, and a non-volatile storage unit 12C such as a hard disk drive (HDD) or a flash memory. The storage unit 12C stores at least a program of a standard application (hereinafter also referred to as a “standard application program”) for performing a process of providing standard functionality (such as a copying function and a facsimile transmission and reception function) of the image forming apparatus 10 to the user of the image forming apparatus 10 and for performing screen control to display on the display unit 18A a screen to provide the standard functionality, and a program of a standard operating system (standard OS) (hereinafter also referred to as a “standard OS program”) functioning as a platform for executing the standard application program. The standard OS may be an example of a first operating system according to the present invention, and the standard application program may be an example of a first application program according to the present invention. The apparatus controller 12 may be an example of an internal computer according to the present invention, and the CPU 12A may function as an example of a first processing unit according to the present invention by executing the standard OS program and the standard application program.

The image forming apparatus 10 according to the exemplary embodiment is also capable of additionally storing a program of an additional application and the like in the storage unit 12C of the apparatus controller 12 to provide additional functionality to the user of the image forming apparatus 10. In FIG. 1, programs for providing additional functionality are indicated by broken lines, and the storage unit 12C of the apparatus controller 12 additionally stores a program of an additional application (hereinafter also referred to as an “additional application program”) for performing a process of providing additional functionality and for performing screen control to display on the display unit 18A a screen for providing the additional functionality or a menu screen, a program of an additional operating system (additional OS) (hereinafter also referred to as an “additional OS program”) functioning as a platform for executing the additional application program, a control program for performing a process such as separating the process implemented by the standard application and the process implemented by the additional application, and a program of a hypervisor (hereinafter also referred to as a “hypervisor program”) that provides functions such as virtualization of hardware resources, arbitration of shared resources between the standard OS and the additional OS, and communication between the standard OS and the additional OS.

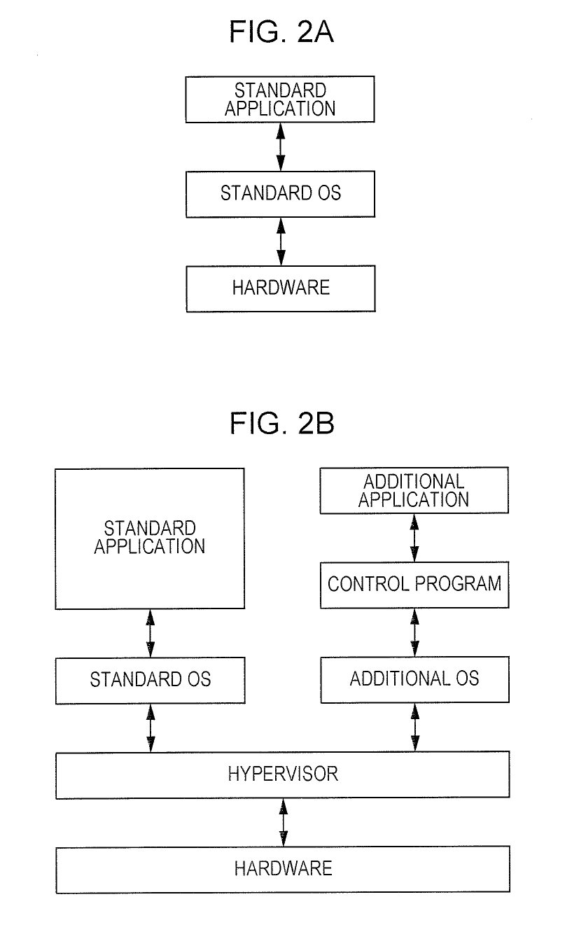

When the storage unit 12C of the apparatus controller 12 does not additionally store an additional program group (including the additional OS program, the additional application program, the control program, and the hypervisor program), the CPU 12A executes the standard OS program in a state where the image forming apparatus 10 is in operation, and also executes the standard application program in an environment where the standard OS is operating (see also FIG. 2A). In this case, in the image forming apparatus 10, a menu screen in which a list of standard functions available is displayed as selection options is displayed on the display unit 18A. When the user selects one of the standard functions displayed as the selection options on the menu screen, an operation screen for specifying the content of a process for providing the selected standard function is displayed on the display unit 18A. When the user specifies content of a process through the operation screen and then instructs execution of the process, a process for controlling the operation of the corresponding H/W module (at least one of the image reading unit 14, the image forming unit 16, and the image information transmitting/receiving unit 20) is performed so that the process corresponding to the specified content of the process may be performed.

When the storage unit 12C of the apparatus controller 12 additionally stores the additional program group described above, a logical partition (virtual environment) assigned to the standard application and the standard OS is different from that assigned to the additional application, the additional OS, and the control program. Further, by way of example, as also illustrated in FIG. 2B, when the image forming apparatus 10 is in operation, a system (standard system) implemented by the standard application operating on the standard OS, and a system (controller system) implemented by the additional application and the control program operating on the additional OS coexist. The standard functionality is provided to the user through cooperation of both systems, and the process for providing the standard functionality is performed by the standard system. When additional functionality is provided to the user, the process for providing the additional functionality is performed by the controller system.

Specifically, in the image forming apparatus 10 that is in an operating state, the CPU 12A (the apparatus controller 12) that executes the additional application program performs screen control for displaying on the display unit 18A a menu screen that provides a list of all the functions available to the user (the standard functionality and the additional functionality) as selection options. Here, if the user selects one of the functions displayed on the menu screen as selection options, in accordance with the control program executed by the CPU 12A, it is determined whether or not the selected function is the standard functionality provided by the standard application or the additional functionality provided by the additional application. If the selected function is the standard functionality provided by the standard application, the process for notifying the standard application of the selection of the standard functionality is performed. Thus, the CPU 12A (the apparatus controller 12) that executes the standard application program causes the operation screen corresponding to the selected function (standard functionality) to be displayed. When the user specifies content of a process through the operation screen and instructs execution of the process, a process for controlling the operation of the corresponding H/W module via the hypervisor is performed so that the process corresponding to the specified content of the process may be performed.

If the user selects the additional functionality provided by the additional application among the functions displayed as selection options on the menu screen, the CPU 12A (the apparatus controller 12) that executes the additional application program causes an operation screen for specifying content of a process for providing the selected additional functionality to be displayed on the display unit 18A. When the user specifies content of a process through the operation screen and then instructs execution of the process, a process for controlling the operation of the corresponding H/W module via the hypervisor is performed so that the process corresponding to the specified content of the process may be performed. In the exemplary embodiment, the process corresponding to the additional functionality provided by the additional application is made open on the computer network as a web service that can be called from outside by specifying the address such as the uniform resource locator (URL).

The additional OS may be an example of a second operating system according to the present invention, and the additional application program may be an example of a second application program according to the present invention. The CPU 12A executes the additional OS program and the additional application program, thereby allowing the apparatus controller 12 to function as an example of a second processing unit according to the present invention. Furthermore, the control program includes an instruction storage program for implementing an instruction storage process described below, and an instruction output program for implementing an instruction output process described below. The CPU 12A executes the control program, thereby allowing the apparatus controller 12 to also function as an example of a receiving unit and a transfer unit according to the present invention and further function as a first output unit or a second output unit according to the present invention.

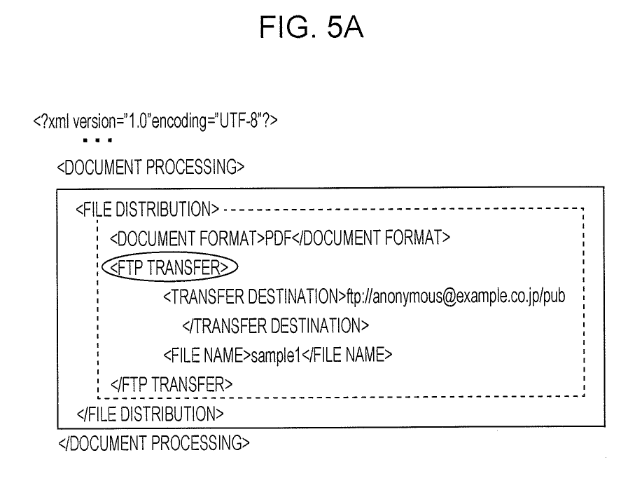

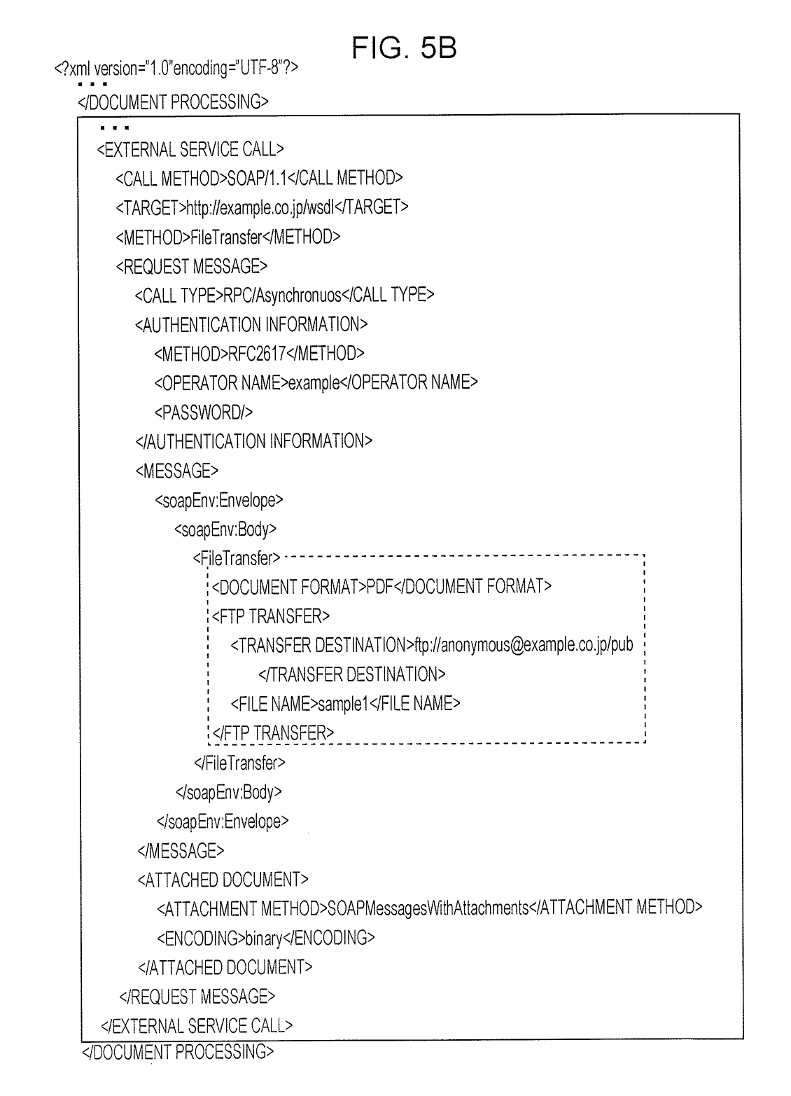

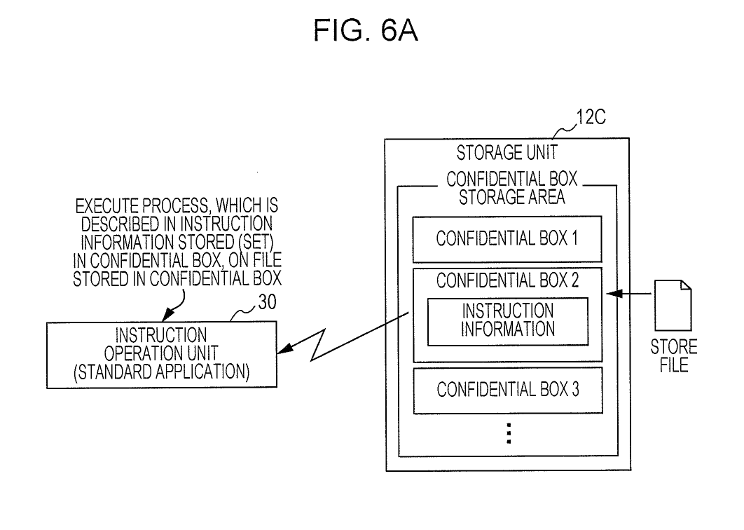

The details of the exemplary embodiment will now be described. In the exemplary embodiment, the user generally uses the image forming apparatus 10 by operating the operation receiving unit 18B of the operation panel 18, selecting an available function through a menu screen, specifying content of a process through an operation screen, and then instructing execution of the process. However, for example, if the process to be executed by the image forming apparatus 10 is a routine process including plural types of processes and providing iterations of the processes, a process that the user wishes to execute each time it is determined that preset execution conditions are satisfied, or any other suitable process, instruction information may be used to utilize the image forming apparatus 10 (or to instruct the image forming apparatus 10 to execute a process). The instruction information may be information in which one or more processes to be executed by the image forming apparatus 101 are described in accordance with a predetermined form as illustrated in FIGS. 5A and 5B or the like, by way of example. The process provided as the standard functionality by executing the standard application program includes an instruction execution process (described in detail below) for interpreting the content of the instruction information and executing the process described in the instruction information as the process to be executed.

Further, the standard application program includes a program of an instruction editor used to create an instruction (or to generate instruction information). Before creating an instruction, the user performs the operation of, first, starting the instruction editor, selecting, through an operation screen displayed on the display unit 18A of the operation panel 18 by the started instruction editor, a process to be described in the instruction, as a process to be executed, from among plural types of processes executable by the image forming apparatus 10, which are recognized by the instruction editor and displayed as selection options on the screen, and specifying content of the selected process. When the operation performed by the user is completed, in accordance with the predetermined form, the instruction editor describes the process selected by the user as the process to be executed, and generates instruction information describing the content of the process specified by the user. The creation of an instruction (or the generation of instruction information) may also be performed by a terminal apparatus such as a PC having the program of the instruction editor installed therein.

Further, the process described in the instruction information may be executed using, as a trigger, the selection of instruction information by the user ahead of the arrival of the execution timing and the instruction of execution of (the process described in) the selected instruction information. Alternatively, execution conditions of (the process described in) instruction information may be set and the (process described in the) instruction information may be executed each time it is determined that the execution conditions are satisfied. The execution conditions of the instruction information include the execution condition “when a file is stored in a specific confidential box (an example of a personal area according to the present invention), the process described in the instruction information is executed on the stored file”. This execution condition may be set in the instruction information by storing (setting) the instruction information to be subjected to setting in a specific confidential box.

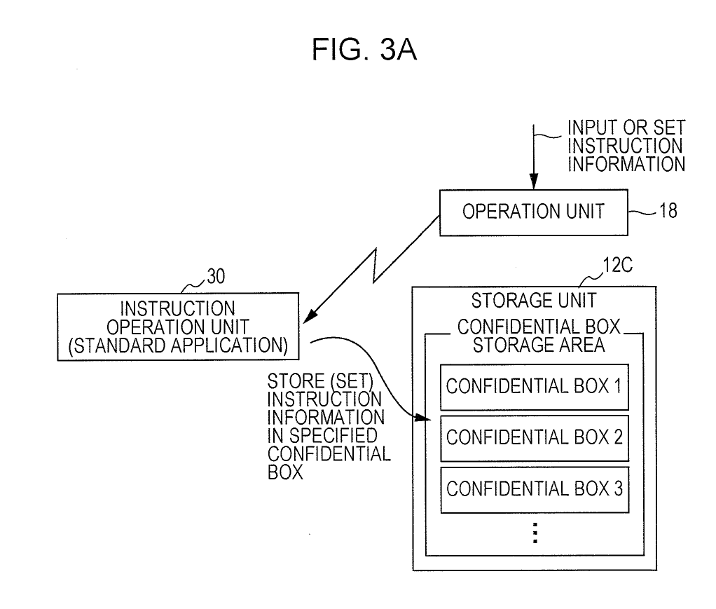

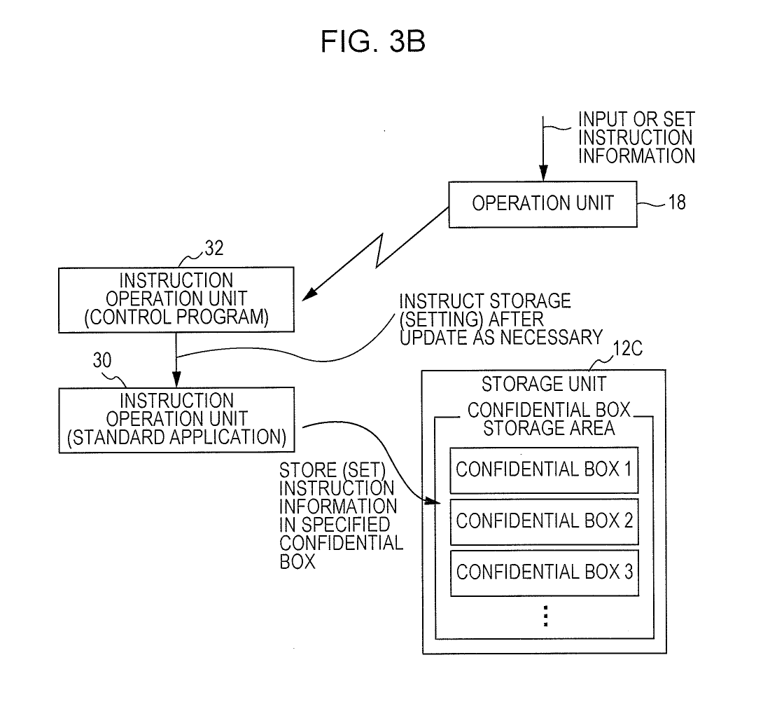

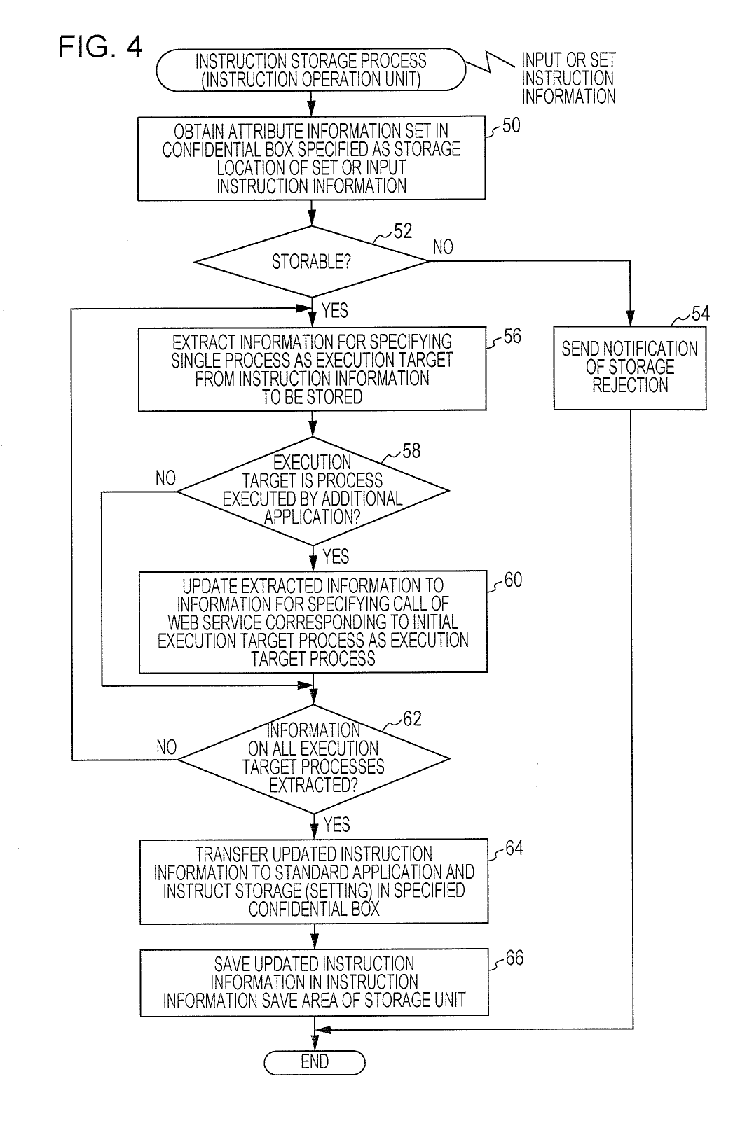

The process provided as standard functionality by executing the standard application program includes an instruction storage process for storing (setting) instruction information in a specified confidential box among confidential boxes established in a confidential box storage area provided in the storage unit 12C of the apparatus controller 12. Furthermore, the standard application program includes a program (instruction operation program) for allowing the apparatus controller 12 to function as an instruction operation unit 30 (see FIG. 3A) that performs the above instruction storage process or the instruction execution process described previously.

In the exemplary embodiment, when the user of the image forming apparatus 10 operates the operation receiving unit 18B of the operation panel 18 to create an instruction (or to generate instruction information) via the instruction editor or when, after already generated instruction information is input from another terminal apparatus, a confidential box in which the instruction information is to be stored (set) is specified and storage (setting) of the instruction information in the specified confidential box is instructed, if the storage unit 12C of the apparatus controller 12 does not additionally store the additional program group, as illustrated in FIG. 3A, the instruction operation program included in the standard application program is starting, thus allowing the apparatus controller 12 to function as the instruction operation unit 30. The instruction operation unit 30 performs a process for storing (setting) the instruction information input or set by the user in a confidential box specified by the user (in the example of FIG. 3A, confidential box 2) among the confidential boxes established in the confidential box storage area of the storage unit 12C.

If the storage unit 12C of the apparatus controller 12 additionally stores the additional program group, the operation of the operation receiving unit 18B performed by the user is monitored during the operation of the image forming apparatus 10 by the CPU 12A (the apparatus controller 12) that executes the control program. If the user of the image forming apparatus 10 instructs storage (setting) of instruction information in a confidential box by operating the operation receiving unit 18B of the operation panel 18, the instruction storage program included in the control program is started, thus allowing the apparatus controller 12 to function as an instruction operation unit 32 (see FIG. 3B). Then, an instruction storage process illustrated in FIG. 4 is performed by the apparatus controller 12. The instruction storage process illustrated in FIG. 4 may be an example of a process performed by the transfer unit according to the present invention, and the process of, as described above, monitoring the operation of the operation receiving unit 18B performed by the user and starting the instruction storage program when storage (setting) of instruction information is instructed may be an example of a process performed by the receiving unit according to the present invention.

In the instruction storage process illustrated in FIG. 4, first, in step 50, attribute information about a confidential box specified by a user who has instructed storage (setting) of instruction information as a storage (setting) location of the instruction information through the operation receiving unit 18B is obtained. Each confidential box may be assigned, as attribute information, for example, information for identifying a user (such as a user ID or user name) who uses the confidential box, the name of the confidential box, an identification number, and authentication information (such as a password). A confidential box as a storage (setting) location of the instruction information may be specified by a user by inputting the name of the confidential box or the identification number. In step 50, attribute information (attribute information about a confidential box specified as a storage (setting) location of the instruction information) associated with the name or identification number input by a user among attribute information about the individual confidential boxes stored in the storage unit 12C is obtained.

Further, when storage (setting) of the instruction information in the confidential box is instructed, the user operates the operation receiving unit 18B of the operation panel 18, thereby also inputting authentication information set in the confidential box specified as the storage (setting) location of the instruction information. Then, in step 52, the authentication information input by the user is compared with the authentication information included in the attribute information obtained in step 50 to determine whether or not the instruction information instructed to be stored (set) in the confidential box can be stored (set) in the specified confidential box. If the authentication information input by the user does not match the obtained authentication information, a negative result is determined in step 52. Then, the process proceeds to step 54, in which a message indicating the instruction information cannot be stored (set) in the confidential box because no match is found for authentication information is displayed on the display unit 18A. Then, the instruction storage process ends.

If a match is found for authentication information, a positive result is determined in step 52. Then, the process proceeds to step 56, in which information specifying a single process as a process to be executed (“execution target”) is extracted from the instruction information instructed to be stored (set) in the confidential box. In step 58, it is determined whether or not a process specified in the information extracted in step 56 as a process to be executed is a process executed by the additional application. If the process specified in the information extracted in step 56 as a process to be executed is a process executed by the standard application, a negative result is determined in step 58, and the process then proceeds to step 62. If the process specified in the information extracted in step 56 as a process to be executed is a process executed by the additional application, a positive result is determined in step 58. Then, the process proceeds to step 60, in which the information extracted in step 56 within the instruction information instructed to be stored (set) in the confidential box is updated to information for instructing execution of a process of calling the web service corresponding to the process to be executed in the extracted information among web services that are made open on the computer network and that are provided by the additional application. Then, the process proceeds to step 62.

In step 62, it is determined whether or not information corresponding to all the processes specified as objects to be executed in the instruction information instructed to be stored (set) in the confidential box has been extracted in step 56. If a negative result is determined, the process returns to step 56 and the processing of steps 56 to 62 is repeated until a positive result is determined in step 62. Thus, information describing a process executed by the additional application among the processes specified as objects to be executed in the instruction information instructed to be stored (set) in the confidential box is updated to information specifying, as a process to be executed, a process for calling a specific web service corresponding to the process executed by the additional application.

For example, as illustrated in FIG. 5A, instruction information instructed to be stored (set) in a confidential box may include information specifying, as processes to be executed, conversion of a document file into the Portable Document Format (PDF) format and File Transfer Protocol (FTP) transfer to a preset server computer, and the conversion into the PDF format and the FTP transfer may be implemented by the additional application. In this case, the above information included in the instruction information may be updated to, as illustrated in FIG. 5B, by way of example, information for instructing execution of a process for calling a web service (external service) that performs FTP transfer among web services that are made open on the computer network and that are provided by the additional application, in such a manner that the original information (information for instructing conversion of the document file into the PDF format and FTP transfer to the preset server computer) is embedded in a message (character string between tag <message> and tag </message>) transmitted from the caller of the web service to the call.

If a positive result is determined in step 62, the process proceeds to step 64, in which the instruction operation program included in the standard application program is started to cause the apparatus controller 12 to also function as the instruction operation unit 30 of the standard application. Thereafter, instruction information that has been updated as necessary through the processing of steps 56 to 62 described above is transferred to the instruction operation unit 30 of the standard application, and storage (setting) of the instruction information in the confidential box specified by the user is instructed. Thus, the instruction operation unit 30 of the standard application performs a process for storing (setting) the instruction information transferred from the instruction operation unit 32 in the confidential box specified by the user (see also “store (set) instruction information in specified confidential box” in FIG. 3B). Then, in step 66, instruction information that has been updated as necessary through the processing of steps 56 to 62 is saved in an instruction information save area provided in the storage unit 12C. Then, the instruction storage process ends.

When the storage unit 12C of the apparatus controller 12 additionally stores the additional program group, the image forming apparatus 10 is also capable of executing the process implemented by the additional application. Thus, as described above, the process implemented by the additional application may be described in the instruction information as a process to be executed. However, in order to cause the instruction operation unit 30 (see FIG. 3A) implemented by the standard application to perform, as an instruction execution process, a process for determining whether or not each of the processes to be executed, which are described in the instruction information, is a process implemented by the additional application and for instructing the additional application to execute the process implemented by the additional application among the processes to be executed, it may be necessary to also update the standard application program when additionally storing the additional program group in the storage unit 12C of the apparatus controller 12.

In the exemplary embodiment, in contrast, when the additional program group is additionally stored in the storage unit 12C of the apparatus controller 12, if storage (setting) of instruction information in a confidential box is instructed, the instruction storage program included in the control program is started, and the instruction storage process illustrated in FIG. 4 is performed by the apparatus controller 12. Therefore, if the instruction information instructed to be stored (set) in a confidential box describes information specifying a process executed by the additional application as a process to be executed, the information is updated to information specifying a process executable by the instruction operation unit 30 of the standard application, that is, information specifying, as a process to be executed, a process for calling a specific web service provided by the additional application.

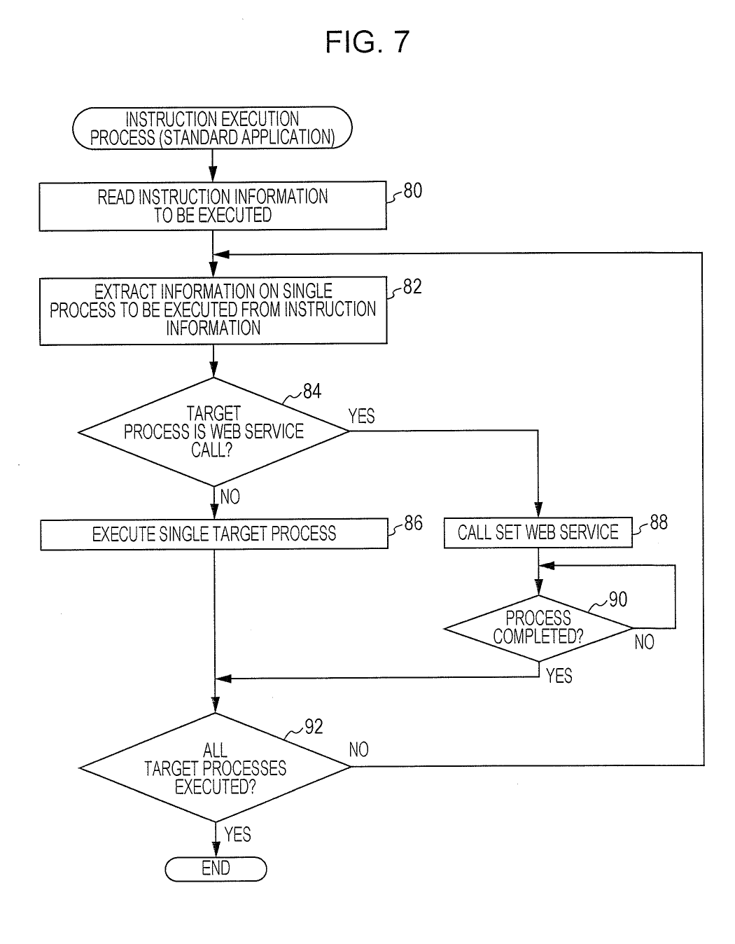

Next, a case where a file is stored in a confidential box in which instruction information is stored (set) will be described. If a file is stored in a confidential box in which instruction information is stored (set), regardless of whether or not the storage unit 12C of the apparatus controller 12 additionally stores the additional program group, as illustrated in FIGS. 6A and 6B, the instruction operation program included in the standard application is started, thereby allowing the apparatus controller 12 to function as the instruction operation unit 30, and an instruction execution process illustrated in FIG. 7 is performed.

In the instruction execution process, first, in step 80, instruction information stored (set) in a confidential box in which a file is stored is read from a confidential box storage area as instruction information to be executed. Then, in step 82, information specifying a single process as an object to be executed is extracted from the instruction information to be executed, which is read in step 80. Further, in step 84, it is determined whether or not the process specified as an object to be executed (“target process”) in the information extracted in step 82 is a process for calling a web service that is made open on a computer network. If a negative result is determined in step 84, the process specified as an object to be executed in the information extracted in step 82 is a process executable by the standard application. Thus, the process proceeds from step 84 to step 86, in which the file stored in the confidential box is subjected to the process specified as an object to be executed in the information extracted in step 82 (for example, a process such as causing the image forming unit 16 to print, as an image, the file stored in the confidential box on recording paper and discharging the recording paper on which the image is printed to a specific paper discharge unit used as a mailbox). Then, the process proceeds to step 92.

If the process specified as an object to be executed in the information extracted in step 82 is a process for calling a web service that is made open on a computer network, the process proceeds from step 84 to step 88, in which a process for calling the web service set in the extracted information is performed. Thus, an external processing unit that provides the called web service performs a web service providing process on the file stored in the confidential box.

Here, the external processing unit that performs a web service providing process may be generally a service processing apparatus such as a server computer or an image forming apparatus connected to a computer network. If the information extracted in step 82 is information (the information updated in step 60 in the above instruction storage process (FIG. 4)) for instructing a call of a web service provided by the additional application additionally stored in the subject apparatus (the image forming apparatus 10), as indicated by “web service call” in FIG. 6B, by way of example, information for calling the web service is transferred via the computer network to the additional application additionally stored in the subject apparatus (the image forming apparatus 10). Then, in accordance with a message attached to the information for calling the web service, the CPU 12A (the apparatus controller 12) that executes the additional application program performs a called web service providing process (such as a process for converting a file stored in a confidential box into the PDF format and performing FTP transfer to a preset server computer) on the file stored in the confidential box.

Then, in step 90, it is determined whether or not the notification of completion of the called web service providing process has been received from the external processing unit. The processing of step 90 is repeated until a positive result is determined. If the notification of completion of the called web service providing process is received from the external processing unit, a positive result is determined in step 90. Then, the process proceeds to step 92. If the web service providing process is performed by the CPU 12A (the apparatus controller 12) that executes the additional application program, as indicated by “completion notification” in FIG. 6B, the notification of completion transmitted by the CPU 12A (the apparatus controller 12) that executes the additional application program is received by the instruction operation unit 30 of the standard application in the subject apparatus (the image forming apparatus 10) via a computer network.

In step 92, it is determined whether or not information corresponding to all the processes specified as objects to be executed in the instruction information read in step 80 has been extracted from the instruction information. If a negative result is determined, the process returns to step 82, and the processing of steps 82 to 92 is repeated until a positive result is determined in step 92. Thus, even when the storage unit 12C of the apparatus controller 12 additionally stores the additional program group, among the processes specified as processes to be executed in the initial instruction information instructed to be stored (set) in a confidential box by the user, the process executed by the standard application is executed by the standard application while the process executed by the additional application is executed by the additional application through a web service call, without updating the standard application program. Then, if a positive result is determined in step 92, the instruction execution process ends.

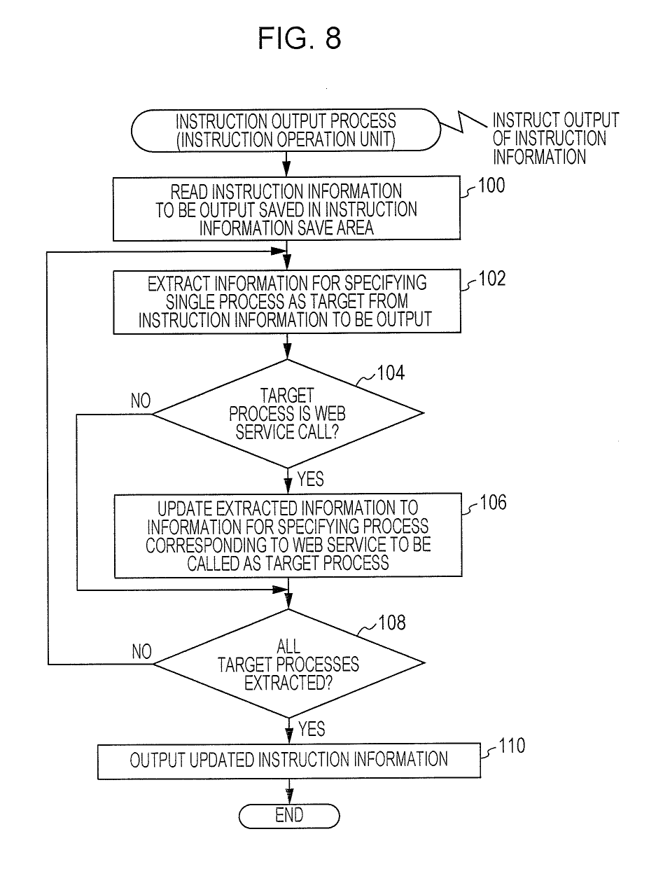

Next, an output of instruction information will be described. When the user wishes to output specific instruction information (such as display the content on the display unit 18A or transmit the specific instruction information to another apparatus), the user operates the operation receiving unit 18B to select specific instruction information that the user wishes to output as an object to be output, and instructs output of the selected instruction information. Here, if the storage unit 12C of the apparatus controller 12 additionally stores the additional program group, in response to the above operation performed by the user, an instruction output program included in the control program is executed by the CPU 12A to perform an instruction output process illustrated in FIG. 8.

In the instruction output process, first, in step 100, instruction information selected as an object to be output by a user within instruction information saved in the instruction information save area of the storage unit 12C is read from the storage unit 12C. Then, in step 102, information specifying a single process as an object to be executed is extracted from the instruction information to be output, which is read in step 100. In step 104, it is determined whether or not the process specified as an object to be executed (“target process”) in the information extracted in step 102 is a process for calling a web service that is made open on a computer network. If a negative result is determined, the process proceeds to step 108. If a positive result is determined in step 104, the process proceeds to step 106, in which the information extracted in step 102 is updated to information (information described in the initial instruction information instructed to be stored (set) in a confidential box by the user) for directly specifying, as a process to be executed, the process (process executed by the additional application) corresponding to the web service to be called in the information. Then, the process proceeds to step 108.

In step 108, it is determined whether or not information corresponding to all the processes specified as objects to be executed (“target processes”) in the instruction information read in step 100 has been extracted from the instruction information. If a negative result is determined, the process return to step 102, and the processing of steps 102 to 108 is repeated until a positive result is determined in step 108. Thus, the initial instruction information instructed to be stored (set) in a confidential box by the user is restored from the instruction information read in step 100. If a positive result is determined in step 108, the process proceeds to step 110, in which the instruction information that has been updated (the restored initial instruction information) is output in accordance with the instruction from the user (for example, displaying the content of the instruction information on the display unit 18A or transmitting the instruction information to another apparatus (for example, a client terminal or another image forming apparatus) specified by the user). Then, the instruction output process ends.

The instruction output process illustrated in FIG. 8 may be an example of a process performed by the second output unit according to the present invention. However, instruction information may be output using any process other than the process illustrated in FIG. 8. For example, in step 66 of the instruction storage process (FIG. 4), instead of saving instruction information that has been updated in the instruction information save area, it may be possible to save instruction information that has not been updated in the instruction information save area and to simply output instruction information selected as an object to be output by the user within the saved instruction information (or to output the selected instruction information without being updated in step 106 of FIG. 8). This process may be an example of a process performed by the first output unit according to the present invention.

In the foregoing description, the exemplary embodiment of the present invention has been described in the context of instruction information that is stored (set) in a confidential box and that is executed when a file is stored in the confidential box, by way of example. However, instruction information according to an exemplary embodiment of the present invention is not limited to instruction information used for the above purposes. For example, instruction information executed each time it is determined that a preset time has arrived, or instruction information selected by a user and executed in accordance with an execution instruction may also be used.

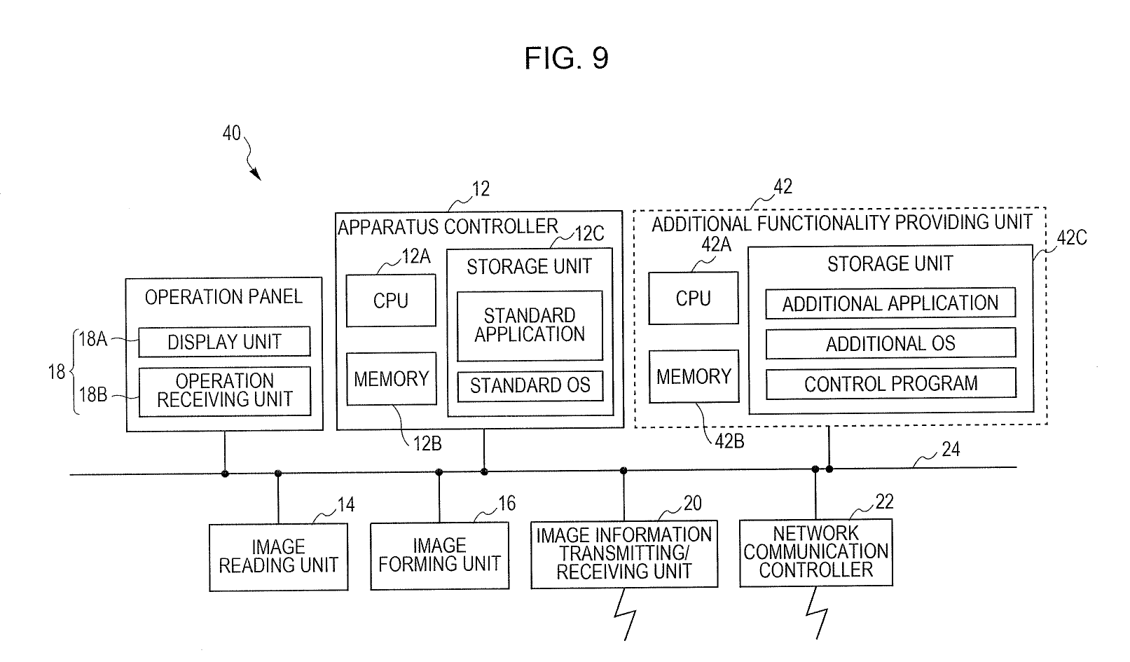

In the foregoing description, furthermore, the standard application program as an example of the first application program and the additional application program as an example of the second application program are executed by the CPU 12A of the apparatus controller 12, by way of example. However, the present invention is not limited to this exemplary embodiment. For example, a configuration as illustrated in FIG. 9 may also be used. That is, additional functionality providing unit 42, which may be formed of a microcomputer or the like, is configured such that a CPU 42A, a memory 42B, and a non-volatile storage unit 42C that stores the additional OS program, the additional application program, and the control program and that has additional-functionality confidential box storage area are mounted on a substrate. The additional functionality providing unit 42 may be placed into an extension slot provided in an image forming apparatus 40 to add functionality that can be provided to the user. The additional functionality providing unit 42 in this configuration may be an example of an additional computer according to the present invention, and the additional OS program, the additional application program, and the control program may be executed by the CPU 42A of the additional functionality providing unit 42. In the configuration illustrated in FIG. 9, for example, the control program may be stored in the storage unit 12C of the apparatus controller 12, and may be executed by the CPU 12A.

In the foregoing description, furthermore, a program as an example of a control program for an image forming apparatus according to the present invention is additionally stored in the storage unit 12C of the apparatus controller 12, by way of example. However, a control program for an image forming apparatus according to the present invention may also be provided in a form recorded on a recording medium such as a compact disc read only memory (CD-ROM) or a digital versatile disc read only memory (DVD-ROM).

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An image forming apparatus comprising:
a first processing unit that is implemented by executing a first application program by using an internal computer in an environment where a first operating system is operating, the first processing unit being configured to perform a process in accordance with instruction information describing a process to be executed, the first processing unit performing a first process when the instruction information describes information specifying the first process as the process to be executed, and performing an external service call when the instruction information describes information specifying the external service call as the process to be executed;
a second processing unit that is implemented by executing a second application program by using the internal computer or an additional computer connected to the internal computer in an environment where a second operating system is operating, the second processing unit being configured to perform a second process when instructed by the external service call to execute the second process;
a receiving unit that receives set or input instruction information describing a process to be executed; and
a transfer unit that, when set or input instruction information is received by the receiving unit, finds whether or not information specifying the second process as the process to be executed is included in the received set or input instruction information, and that, when information specifying the second process as the process to be executed is included, updates the information included in the instruction information to information specifying, as a process to be executed, the external service call for instructing the second processing unit to execute the second process and transfers the instruction information that has been updated to the first processing unit.

2. The image forming apparatus according to claim 1, further comprising a first output unit,
wherein the transfer unit causes the instruction information that has not been updated to be stored in a memory,
wherein the receiving unit further receives output instruction information that is stored in the memory, and
wherein when the output instruction information is received by the receiving unit, the first output unit reads the instruction information that has not been updated from the memory and outputs the read instruction information.

3. The image forming apparatus according to claim 1, further comprising a second output unit,
wherein the transfer unit causes the instruction information that has been updated to be stored in a memory,
wherein the receiving unit further receives output instruction information that is stored in the memory, and
wherein when the output instruction information is received by the receiving unit, the second output unit reads the instruction information that has been updated from the memory and outputs the read instruction information after returning the information specifying, as a process to be executed, the external service call for instructing the second processing unit to execute the second process, which is included in the read instruction information, to the information specifying the second process as the process to be executed.

4. The image forming apparatus according to claim 1, wherein the instruction information transferred from the transfer unit to the first processing unit is stored in a personal area corresponding to a user who has set or input the set or input instruction information among personal areas established on a user-by-user basis in a memory area of a memory, and
wherein when a file is stored in the personal area, the first processing unit processes the stored file in accordance with the instruction information stored in the personal area.

5. The image forming apparatus according to claim 1, wherein the first processing unit performs, as the first process, a process for implementing standard functionality that is provided to a user by the image forming apparatus,
wherein the second processing unit performs, as the second process, a process for implementing additional functionality that is provided to a user by the image forming apparatus, the second processing unit being additionally attached to the image forming apparatus by additionally storing at least a program of the second operating system and the second application program in a memory or by connecting the additional computer to the internal computer, the additional computer including an additional memory that stores at least the program of the second operating system and the second application program, and
wherein the receiving unit and the transfer unit are additionally attached to the image forming apparatus together with the second processing unit.

6. A computer readable medium storing a control program for an image forming apparatus, the control program including
a second application program for causing an internal computer of the image forming apparatus or an additional computer connected to the internal computer, the internal computer functioning as a first processing unit, to function as a second processing unit,
the first processing unit being implemented by executing a first application program by using the internal computer in an environment where a first operating system is operating, the first processing unit being configured to perform a process in accordance with instruction information describing a process to be executed, the first processing unit performing a first process when the instruction information describes information specifying the first process as the process to be executed, and performing an external service call when the instruction information describes information specifying the external service call as the process to be executed,
the second processing unit being implemented by executing a second application program by using the internal computer or the additional computer connected to the internal computer in an environment where a second operating system is operating, the second processing unit being configured to perform a second process when instructed by the external service call to execute the second process,
the control program causing the internal computer or the additional computer to function as:
a receiving unit that receives set or input instruction information describing a process to be executed; and
a transfer unit that, when set or input instruction information is received by the receiving unit, finds whether or not information specifying the second process as the process to be executed is included in the received set or input instruction information, and that, when information specifying the second process as the process to be executed is included, updates the information included in the instruction information to information specifying, as a process to be executed, the external service call for instructing the second processing unit to execute the second process and transfers the instruction information that has been updated to the first processing unit.

7. An image forming method comprising:
implementing a first processing unit by executing a first application program by using an internal computer in an environment where a first operating system is operating;
performing a process in accordance with instruction information describing a process to be executed;
performing a first process when the instruction information describes information specifying the first process as the process to be executed;
performing an external service call when the instruction information describes information specifying the external service call as the process to be executed;
implementing a second processing unit by executing a second application program by using the internal computer or an additional computer connected to the internal computer in an environment where a second operating system is operating;
performing a second process when instructed by the external service call to execute the second process;
receiving set or input instruction information describing a process to be executed;
when set or input instruction information is received, finding whether or not information specifying the second process as the process to be executed is included in the received set or input instruction information; and
when information specifying the second process as the process to be executed is included, updating the information included in the instruction information to information specifying, as a process to be executed, the external service call for instructing the second processing unit to execute the second process and transfers the instruction information that has been updated to the first processing unit.
